(19) United States
(12) Patent Application Publication
(10) Pub. No.: US 2005/0111412 A1
(43) Pub. Date: May 26, 2005

(54) Method for dynamically adjusting a target load for reverse link channel in a CDMA network

(76) Inventors: Patrick A. Hosein, San Diego, CA (US); Wanshi Chen, San Diego, CA (US); Tao Wu, Carlsbad, CA (US)

Correspondence Address: COATS & BENNETT, PLLC, P O BOX 5, RALEIGH, NC, 27602, US

(21) Appl. No.: 10/718,145

(22) Filed: Nov. 20, 2003

(51) Int. Cl. H04Q 7/00

(52) U.S. Cl. 370/333

(57) ABSTRACT

A method of determining a target load for a reverse link channel in a CDMA base station, comprises determining a target frame error rate for a base station and computing the target load as a function of the target frame error rate and a measured frame error rate.

### BACKGROUND OF THE INVENTION

In CDMA networks, the mobile stations share a reverse link channel and may transmit simultaneously. During transmission, each mobile station spreads its transmitted signal with a spreading code selected from a set of mutually orthogonal spreading codes. The base station is able to separate the signals received from the mobile stations by a correlation process. For example, if the base station desires to receive the signal transmitted by mobile station A, the base station correlates the received signal to the spreading code used by mobile station A to despread the signal from mobile station A. All other signals will appear as noise due to lack of correlation. The base station can despread signals from all other mobile stations in the same manner.

CDMA networks are interference-limited systems. Since all mobile stations operate at the same frequency, internal interference generated within the network plays a critical role in determining system capacity and signal quality. The transmit power from each mobile station contributes to the noise floor and needs to be controlled to limit interference while maintaining desired performance objectives, e.g., bit error rate (BER), frame error rate (FER), capacity, dropped-call rate, coverage, etc. If the noise floor is allowed to get too high, widespread outages may occur. An outage is considered to occur when the power required to maintain minimum signal quality standards is greater than the maximum transmit power of the mobile station.

Rate control is one technique used to control the load on a reverse link channel in a CDMA network. In general, the transmit power required to maintain a desired signal quality increases as the data rate for transmission increases, and decreases as the data rate for transmission decreases. Thus, base station may control the reverse link load by controlling the data transmission rates of the mobile stations transmitting on the reverse link channel.

A variety of rate control techniques are known for controlling the data transmission rates of mobile stations on a reverse link channel. Known rate control techniques include common rate control, dedicated rate control, and scheduling. The goal of all of the above described rate control techniques is to maintain the reverse link load at a desired target load chosen such that the frequency of outages is below some predetermined amount, e.g. 1%. The actual reverse link load will fluctuate around the target load. If the target load is set too high, the frequency of outages may exceed the desired amount resulting in poor perceived quality of serve (QoS). On the other hand, if the target load is set too low, system thoughput is diminished. Therefore, the target load reflects a balance between system QoS objectives and system throughput.

In systems using rate control for reverse link channels, it is desirable to dynamically adjust the target load. When the target load is fixed, the target load must be conservatively set to a value that will meet the desired QoS objectives under the poorest anticipated conditions. Setting the target load to a fixed value reduces the throughput that could be obtained under more favorable conditions. If the target load could be adjusted, the target load could be moved closer to the maximum load when the fluctuations in the reverse link load are small to increase system throughput while conditions are advantageous. Conversely, when the fluctuations are large, the target load could be adjusted downward to maintain the QoS objectives. Thus, by dynamically adjusting the target load, system throughout can be increased as compared to systems where the target load is fixed.

### SUMMARY OF THE INVENTION

The present invention relates to a method and apparatus for dynamically adjusting the target load used by the base station for rate control. The base station periodically adjusts the target load to maintain a desired target frame error rate. The target frame error rate may be a frame error rate at a base station controller after frame selection. Alternatively, the target frame error rate may be a frame erasure rate at the base station.

In some embodiments, the base station computes a ratio of the measured frame erasure rate at the base station to a target frame erasure rate and calculates an adjustment factor based on the ratio. In other embodiments of the invention, the base station compares the measured frame erasure rate to a target frame erasure rate and increments or decrements the target load by fixed amounts depending upon the outcome of the comparison. Different target frame error rates for different groups of mobile stations may be taken into account in calculating the target load.

### BRIEF DESCRIPTION OF THE DRAWINGS

FIG. 1 is a diagram of an exemplary wireless communication network according to one or more embodiments of the present invention.

FIG. 2 is a diagram of exemplary functional details for a radio base station according to the present invention.

FIG. 3 is a diagram illustrating a load curve for a reverse link channel in a CDMA network.

### DETAILED DESCRIPTION OF THE INVENTION

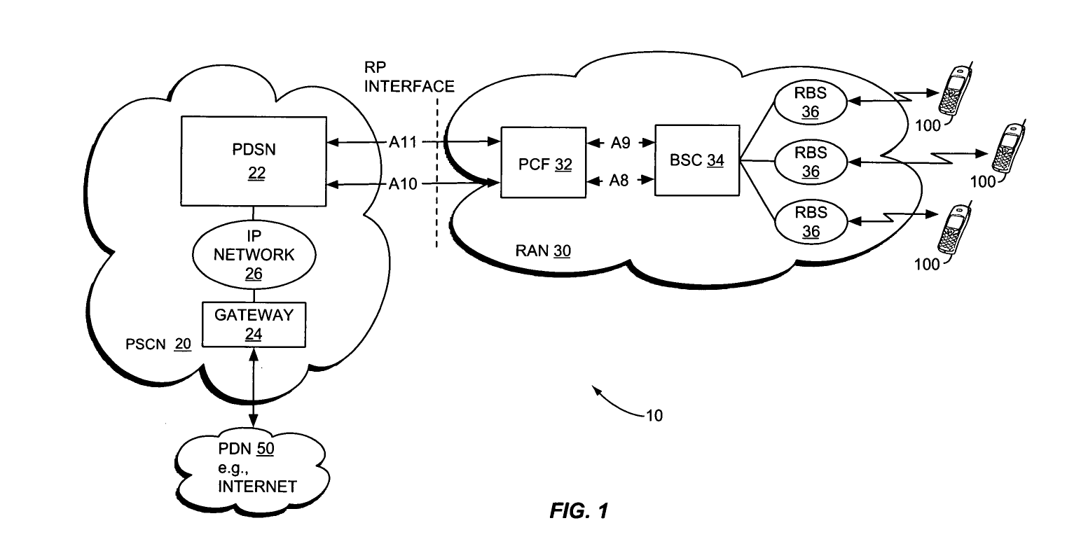

Turning to the drawings, FIG. 1 illustrates an exemplary wireless communication network 10 in which the present invention may be implemented. Network 10 may be any packet-switched communication network, for example, cdma2000 wireless network according to the IS-2000/2001 families of standards. However, those skilled in the art will appreciate that the wireless communication network may be configured according to other standards, including Wideband CDMA (WCDMA) standards.

Network 10 includes a Packet-Switched Core Network (PSCN) 20 and a Radio Access Network (RAN) 30. The PSCN 20 provides connection to one or more Public Data Networks (PDNs) 50, such as the Internet. The PSCN 20 includes a packet data serving node (PDSN) 22, a gateway 24, and an IP network 26. The details of the PSCN 20 are not material to the present invention and, therefore, the PSCN 20 is not discussed further herein. The RAN 30 provides the radio interface between the mobile stations 100 and the PCSN 12. An exemplary RAN 30 comprises a Packet Control Function (PCF) 32, one or more Base Station Controllers (BSC) 34, and a plurality of Radio Base Stations (RBSs) 36. BSCs 34 connect to the RBSs 36 to the PCF 32. Mobile stations 100 communicate with the RBSs 36 via the air interface as defined by the appropriate network standards, such as the IS-2000 family of standards.

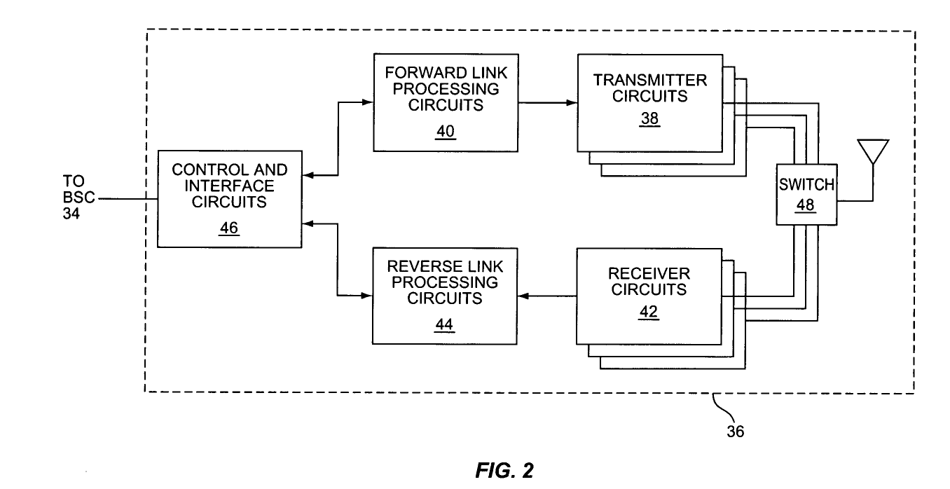

FIG. 2 illustrates a functional diagram of an exemplary RBS 36 according to one embodiment of the present invention. It will be appreciated that the present invention is not limited to the RBS architecture illustrated in FIG. 2, and that other RBS architectures are applicable to the present invention. The functional elements of FIG. 2 may be implemented in software, hardware, or some combination of both. For example, one or more of the functional elements in RBS 36 may be implemented as stored program instructions executed by one or more microprocessors or other logic circuits included in RBS 36.

As shown in FIG. 2, RBS 36 includes transmitter circuits 38, forward link signal processing circuits 40, receiver circuits 42, reverse link signals processing circuits 44, and control and interface circuits 46. The transmitter circuits 38 include the necessary RF circuits, such as modulators and power amplifiers, to transmit signals to mobile stations 100. The forward link signal processing circuits 40 process the signals being transmitted to the mobile stations 100. Forward link signal processing may include digital modulation, encoding, interleaving, encryption, and formatting. The receiver circuits 42 comprise the RF components, such as a receiver front end, necessary to receive signals from the mobile stations 100. Reverse link processing circuits 44 process the signals received from the mobile stations 100. Reverse link processing may include, for example, digital demodulation, decoding, de-interleaving, and decryption. Control and interface circuits 46 coordinate the operation of the RBS 36 and the mobile stations 100 according to the applicable communication standards and interface the RBS 36 with the BSC 34. The forward link processing circuits 40, reverse link processing circuits 44, and control and interface circuits 46 may be integrated in a single processor, or may be implemented in multiple processors, hardware circuits, or a combination of processors and hardware circuits.

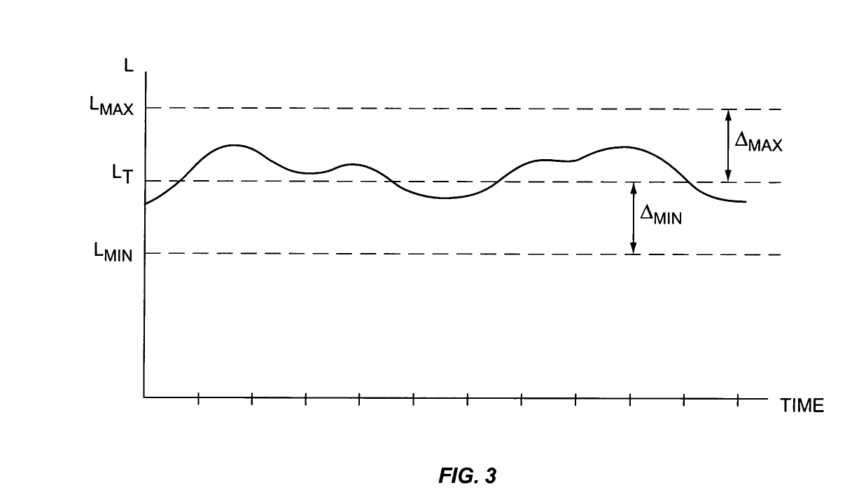

A plurality of mobile stations 100 communicates with the RBS 36 over a reverse link channel. RBS 36 controls the data transmission rate of the mobile stations 100 transmitting on the reverse link channel to maintain the reverse link load at a desired target load L_{T}. FIG. 3 illustrates an exemplary load curve for a reverse link channel. RBS 36 may employ any known techniques for rate control, including scheduling, dedicate rate control, or common rate control. According to the present invention, the RBS 36 periodically adjusts the target load L_{T} to maximize throughput while maintaining a desired quality of service (QoS) objective. In one embodiment of the invention, the RBS 36 adjusts the target load L_{T} to provide a frame error rate (FER) of approximately 1% after frame selection by the BSC 34.

In CDMA networks 10, the mobile stations 100 in soft handoff will have more than one RBS 36 in their active set. Thus, a frame transmitted by a given mobile station 100 in soft handoff will be received by two or more RBSs 36. If the received frame at an RBS 36 is decodable, the RBS 36 forwards the frame to the BSC. Thus, the BSC 34 may receive the same frame from multiple RBSs 36. When multiple copies of the same frame are received by the BSC 34, the BSC 34 selects the frame with the maximum reverse frame quality to forward to the PCF 32.

A frame erasure occurs when a frame received by an RBS 36 is not decodable. The RBS 36 signals the BSC 34 when a frame erasure occurs. Even though a frame erasure may occur at one RBS 36, the BSC 34 may nevertheless receive the frame without error from another RBS 36. A frame error occurs when a frame transmitted by a mobile station 100 is not correctly received by any RBS 36. The term frame error rate (FER) as used in the description refers to the rate of frame errors at the BSC 34 to distinguish it from the frame erasure rate at the RBS 36. However, the term frame error rate as used in the claims should be broadly construed to include the frame erasure rate at the RBS 36.

From the foregoing, it is apparent that the frame erasure rate at the RBS 36 will typically be higher than the frame error rate (FER) after frame selection at the BSC 34. The ratio of the frame erasure rate at a given RBS 36 to the FER after frame selection at the BSC 34 will typically be in the order of five to one. This error ratio, denoted by the constant c, may be determined empirically from field data. If the target FER after frame selection at the BSC 34 is denoted by FER_{T}, the target frame erasure rate, denoted at the RBS 36 is given by:
\hat{ε}=c*FER_{T}, Eq. 1
where \hat{ε} is the target frame erasure rate. In the various embodiments described below, the target frame erasure rate \hat{ε} is used to periodically update the target load at the RBS 36.

The RBS 36 according to a first embodiment of the present invention uses the target frame erasure rate \hat{ε} to periodically adjust the target load L_{T} used by the RBS 36 for rate control. In general, the RBS 36 attempts to maintain the average frame erasure rate at the RBS 36 for all mobile stations 100 as close as possible to the target frame erasure rate. The average frame erasure rate for RBS 36 at period n is denoted by ε(n). During each control period, which is typically one frame, the RBS 36 counts the number of erased frames from all mobile stations 100 transmitting on the reverse link channel and divides the total number of erased frames by the total number of frames received to compute the average frame erasure rate ε(n). The computation of the average frame erasure rate ε(n) may exclude mobile stations 100 that are out of lock on the reverse link. The RBS 36 uses the average frame erasure rate ε(n) to dynamically adjust the target load. Denoting the target load at period n as L_{T}(n), the target load at period n+1 may be computed according to:

$${L}_{T} ( n + 1 ) = min \{ {L}_{MAX} , ( α + ( 1 - α ) \frac{\hat{ɛ}}{ɛ ( n )} ) {L}_{T} ( n ) \} \qquad Eq . 2$$

In Eq. 2, the term α alpha is a smoothing factor to smooth changes in the target load L_{T} (n) in response to large fluctuations in the reverse link load. The term

$$\frac{\hat{ɛ}}{ɛ ( n )}$$

is the ratio of the target frame erasure rate to the measure frame erasure rate at time n. The target load is capped at some maximum load value L_{MAX}. In one exemplary embodiment of the invention, \hat{ε}=5%, α=0.9, and L_{MAX}=0.7.

The RBS 36 adjusts the target load once per control interval, e.g., once per frame. If the average frame erasure rate ε(n) at the RBS 36 increases, the ratio

$$\frac{\hat{ɛ}}{ɛ ( n )}$$

becomes smaller and the RBS 36 reduces the target load L_{T} to maintain the desired FER at the BSC 34. Conversely, if the frame erasure rate ε(n) at the RBS 36 decreases, the ratio

$$\frac{\hat{ɛ}}{ɛ ( n )}$$

will become larger and the RBS 36 will increase the target load L_{T} to increase the system throughput. As noted above, the RBS 36 may use any known rate control techniques to increase or decrease the target load L_{T}, including scheduling, dedicated rate control, and common rate control.

In the embodiment described above, the magnitude of the changes in the target load L_{T} varies depending on the measured frame erasure rate at the RBS 36. In other embodiments, the magnitude of the changes in the target load L_{T} may be constrained to fixed step sizes. The step sizes may be different for increases and decreases in the target load L_{T}. Assume that a fixed step size Step_{D} and Step_{U} is defined for downward adjustments and upward adjustments respectively in the target load L_{T}. In a second embodiment of the present invention. The upward adjustments may be related to the downward adjustments by:

$${Step}_{U} = \frac{{Step}_{D}}{\frac{1}{\hat{ɛ}} - 1} \qquad Eq . 3$$

The RBS 36 in the second embodiment compares the average frame erasure rate ε(n) for all mobile stations 100 to the target frame erasure rate \hat{ε}. If ε(n)>\hat{ε}, the RBS 36 decreases the target load L_{T} by Step_{D}. Conversely, if ε(n)<\hat{ε}, the RBS 36 increases the target load L_{T} by Step_{U}.

A per user step size may be defined and used to calculate the changes to the target load L_{T}. Assume that fixed per user step sizes Step_{D} and Step_{U} are defined respectively for upward and downward adjustments to the target load for each user k in a third embodiment of the invention. Step_{D}(k) and Step_{U}(k) may be related as set forth in Eq. 3 above. The change Δ in the target load L_{T} may be calculated by:

$$Δ = {\sum }_{k}^{} \{ FQI ( k ) * {Step}_{U} ( k ) - ( 1 - FQI ( k ) ) * {Step}_{D} ( k ) \} , \qquad Eq . 4$$

where FQI(k) is a frame quality indicator having a value of 1 for a good frame or 0 for a bad frame. In this example, the target load L_{T} is adjusted every frame according to:
L_{T}(n+1)=L_{T}(n)+Δa, Eq. 5
where a is a weighting factor. Note that Step_{D}(k) and Step_{U}(k) may be the same for all users, in which case Step_{D}(k) and Step_{U}(k) may be replaced by Step_{D} and Step_{U} in Eq. 5.

The methods described above can be modified to accommodate different target FERs for different mobile stations 100. Assume as in the previous embodiment that per user step sizes are defined and that the step size Step_{D} for downward changes is the same for all mobile stations 100. Note that it is not required that the downward step size Step_{D} be the same for all users. Different downward step sizes could be defined, for example, for different user classes. Further assume that the target FER for mobile station k corresponds to a target frame erasure rate \hat{ε}(k) for the mobile station 100. The upward step size Step_{U} for upward adjustments to the target load L_{T} may be calculated for each mobile station k according to:

$${Step}_{U} ( k ) = \frac{{Step}_{D}}{\frac{1}{\hat{ɛ} ( k )} - 1} \qquad Eq . 6$$

The changes to the target load L_{T} for RBS 36 may then be computed by summing the per user changes for all mobile stations 100. The calculation of the change Δ is given by Eq. 4 and the calculation of the new target load is according to Eq. 5.

The computed upward adjustment Step_{U} from Eq. 6 may be larger by a significant amount than the configured downward adjustment Step_{D}. In order to avoid sharp increases in the target load L_{T}, the upward adjustment may be limited to a defined maximum adjustment.

Substituting Eq. 6 into Eq. 4, the calculation of the change in the target load becomes:

$$\begin{matrix}Δ = {\sum }_{k}^{} \{ \frac{\hat{ɛ} ( k )}{1 - \hat{ɛ} ( k )} FQI ( k ) - ( 1 - FQI ( k ) ) \} * {Step}_{D} \\ = {\sum }_{k}^{} \{ \frac{FQI ( k )}{1 - \hat{ɛ} ( k )} - 1 \} * {Step}_{D}\end{matrix} \qquad Eq . 7$$

Substituting Eq. 7 into Eq. 5, the equation for the calculation of the new target load L_{T} becomes:

$${L}_{T} ( n + 1 ) = {L}_{T} ( n ) + a {\sum }_{k}^{} \{ \frac{FQI ( k )}{1 - \hat{ɛ} ( k )} - 1 \} * {Step}_{D} \qquad Eq . 8$$

In the case where the target FER is the same for all mobile stations 100, Eq. 8 simplifies to:

$${L}_{T} ( n + 1 ) = {L}_{T} ( n ) + a {\sum }_{k}^{} \{ \frac{FQI ( k )}{1 - \hat{ɛ}} - N \} * {Step}_{D} , \qquad Eq . 9$$

where N is the total number of mobile stations 100 and k is the target frame erasure rate for all mobile stations 100.

The RBS 36 may use the target load L_{T} for rate control. Any known rate control techniques may be used, including common rate control, dedicated rate control, and scheduling. In systems using three state common rate control, fixed offsets Δ_{MAX} and Δ_{MIN} may be used to determine the maximum load L_{MAX} and minimum load L_{MIN} from the target load L_{T} as shown in FIG. 3. The various techniques described herein could be modified to calculate a maximum load L_{MAX}, a minimum load L_{MIN}, or other load threshold.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A method of determining a target load for a reverse link channel in a wireless communication network, comprising:
determining a target frame error rate; and
computing the target load as a function of the target frame error rate.

2. The method of claim 1 wherein the target frame error rate is the frame error rate after frame selection by a base station controller.

3. The method of claim 1 wherein computing the target load as a function of the target frame error rate comprises:
determining a target frame erasure rate for a radio base station that approximately yields the desired frame error rate; and
computing the target load as a function of the target frame erasure rate.

4. The method of claim 3 wherein computing the target load as a function of the target frame erasure rate comprises:
computing an adjustment factor as a function of the target frame erasure rate; and
multiplying a current target load by the adjustment factor to get a new target load.

5. The method of claim 4 wherein computing an adjustment factor as a function of the target frame erasure rate comprises determining an error ratio based on the ratio of a measured frame erasure rate for a current period to the target frame erasure rate, and computing the adjustment factor based on the error ratio.

6. The method of claim 5 wherein the adjustment factor is computed according to:
$$( α + ( 1 - α ) \frac{\hat{ɛ}}{ɛ ( n )} ) {L}_{T} ( n ) ,$$
where α is a smoothing factor, \hat{ε} is the desired target frame erasure rate, and ε(n) is the measured frame erasure rate at period n.

7. The method of claim 6 wherein the target load is limited to a load less than or equal to a maximum load.

8. The method of claim 3 wherein computing the target load as a function of the target frame erasure rate comprises:
computing a target load adjustment as a function of the target frame erasure rate and a measured frame erasure rate; and
adding the target load adjustment to a current target load to get a new target load.

9. The method of claim 8 wherein the target load adjustment is variable depending on the measured frame erasure rate.

10. The method of claim 8 wherein the target load adjustment is a fixed amount.

11. The method of claim 10 wherein the target load adjustment is different for upward adjustments and downward adjustments.

12. The method of claim 1 wherein determining a target frame error rate comprises determining an average target frame error rate for a plurality of mobile stations.

13. The method of claim 1 wherein determining a target frame error rate comprises determining user dependent target frame error rates for a plurality of mobile stations.

14. The method of claim 13 wherein computing the target load as a function of the target frame error rate comprises determining a per user target load adjustment based on the user dependent target frame error rates, summing the per user target load adjustments to obtain a combined target load adjustment, and adding the combined target load adjustment to a current target load to obtain a new target load.

15. The method of claim 1 further comprising controlling data transmission rates of mobile stations transmitting on the reverse link channel to maintain a measured reverse link load approximately equal to the target load.

16. A base station comprising:
receive circuits to receive simultaneous signals from a plurality of mobile stations over a shared reverse link channel;
control circuits for determining a target load for controlling data transmission rates of mobile stations transmitting on the reverse link channel, the control circuits operative to:
determine a target frame error rate;
compute the target load as a function of the target frame error rate.

17. The base station of claim 16 wherein the target frame error rate is the frame error rate at a base station controller after frame selection.

18. The base station of claim 16 wherein the control circuits compute the target load by:
determining a target frame erasure rate at the base station that yields the target frame error rate; and
computing the target load as a function of the target frame erasure rate.

19. The base station of claim 18 wherein computing the target load as a function of the target frame erasure rate comprises:
computing an adjustment factor as a function of the target frame erasure and a measured frame erasure rate; and
multiplying the current target load by the adjustment factor to get a new target load.

20. The base station of claim 19 wherein computing an adjustment factor as a function of the target frame error rate and a measured frame error rate comprises determining an error ratio based on the ratio of the measured frame erasure rate for a current period to the target frame erasure rate, and computing the adjustment factor based on the error ratio.

21. The base station of claim 20 wherein the adjustment factor is computed according to:
$$( α + ( 1 - α ) \frac{\hat{ɛ}}{ɛ ( n )} ) {L}_{T} ( n ) ,$$
where α is a smoothing factor, \hat{ε} is the desired target frame erasure rate, and ε(n) is the measured frame erasure rate at period n.

22. The base station of claim 21 wherein the target load is limited to a load less than or equal to a maximum load.

23. The base station of claim 18 wherein computing the target load as a function of the target frame erasure rate:
computing a target load adjustment as a function of the target frame erasure rate and a measured frame erasure rate; and
adding the target load adjustment to a current target load to get a new target load.

24. The base station of claim 23 wherein the target load adjustment is variable depending on the measured frame erasure rate.

25. The base station of claim 24 wherein the target load adjustment is a fixed amount.

26. The base station of claim 25 wherein the target load adjustment is different for upward adjustments and downward adjustments.

27. The base station of claim 16 wherein the target frame error rate is an average target frame error rate for a plurality of mobile stations.

28. The base station of claim 16 wherein the target frame error rate comprises user dependent target frame error rates for a plurality of mobile stations.

29. The base station of claim 28 wherein computing the target load as a function of the target frame error rate comprises determining a per user target load adjustment based on the user dependent target frame rates, summing the per user target frame adjustments to obtain a combined target load adjustment, and adding the combined target load adjustment to a current target load to obtain a new target load.

30. The base station of claim 16 further wherein the control circuits further control the data transmission rates of mobile stations transmitting on a reverse link channel to maintain a measured reverse link load approximately equal to the target load.

31. A method of determining a load threshold used for rate control in a reverse link channel in a wireless communication network, comprising:
determining a target frame error rate;
computing the load threshold as a function of the target frame error rate.

32. The method of claim 31 wherein the load threshold is a maximum load.

33. The method of claim 31 wherein the load threshold is a minimum load.

34. The method of claim 31 further wherein determining a target frame error rate comprises determining user dependent target frame error rates for a plurality of mobile stations.

35. The method of claim 34 wherein computing the target load as a function of the target frame error rate comprises computing a combined target load adjustment based on the user dependent target frame error rates for the plurality of mobile stations.

36. The method of claim 35 wherein computing a combined target load adjustment based on the target frame error rates for the plurality of mobile stations comprises determining a per user target load adjustment based on the user dependent target frame error rates, summing the per user target load adjustments to obtain a combined target load adjustment, and adding the combined target load adjustment to a current target load to obtain a new target load.

37. A method of determining a target load for a reverse link channel in a wireless communication network, comprising:
measuring a frame error rate;
computing the target load as a function of the measured frame error rate and a target frame error rate.

38. The method of claim 37 wherein the measured frame error rate is the frame erasure rate at a base station.

39. The method of claim 38 wherein the target frame error rate is a target frame erasure rate at the base station.

40. The method of claim 39 wherein the target frame erasure rate at the base station is selected to yield a desired frame error rate after frame selection at a base station controller.

41. The method of claim 37 wherein computing the target load as a function of the measured frame error rate and a target frame error rate comprises:
computing an adjustment factor; and
multiplying a current target load by the adjustment factor to obtain a new target load.

42. The method of claim 41 wherein computing an adjustment factor comprises computing a ratio of the target frame error rate to the measured frame error rate.

43. The method of claim 37 wherein computing the target load as a function of the measured frame error rate and a target frame error rate comprises:
computing a target load adjustment; and
adding the target load adjustment to a current target load to obtain a new target load.

44. The method of claim 43 wherein the target load adjustment is variable depending on the measured frame error rate.

45. The method of claim 43 wherein the target load adjustment is fixed.

46. The method of claim 45 wherein the target load adjustment is different for upward and downward adjustments.

47. A base station comprising:
receive circuits to receive simultaneous signals from a plurality of mobile stations over a shared reverse link channel;
a circuit to measure a frame error rate;
control circuits for determining a target load for controlling data transmission rates of mobile stations transmitting on the reverse link channel, wherein the target load is determined as a function of the measured frame error rate and a target frame error rate.

48. The base station of claim 47 wherein the measured frame error rate is the frame erasure rate at a base station.

49. The base station of claim 48 wherein the target frame error rate is a target frame erasure rate at the base station.

50. The base station of claim 49 wherein the target frame erasure rate at the base station is selected to yield a desired frame error rate after frame selection at a base station controller.

51. The base station of claim 47 wherein the control circuits compute the target load by:
computing an adjustment factor; and
multiplying a current target load by the adjustment factor to obtain a new target load.

52. The base station of claim 51 wherein the control circuits compute the factor by computing a ratio of the target frame error rate to the measured frame error rate.

53. The base station of claim 47 wherein the control circuits compute the target load by:
computing a target load adjustment; and
adding the target load adjustment to a current target load to obtain a new target load.

54. The base station of claim 43 wherein the control circuits compute a variable target load adjustment depending on the measured frame error rate.

55. The base station of claim 43 wherein the target load adjustment is fixed.

56. The base station of claim 45 wherein the target load adjustment is different for upward and downward adjustments.
